(19) United States
(12) Patent Application Publication
(10) Pub. No.: US 2010/0028624 A1
(43) Pub. Date: Feb. 4, 2010

(54) SNAG FREE REVERSIBLE CAMOUFLAGE NETTING

(76) Inventors: Scott Duane Smith, Willow Spring, NC (US); William Nathan Easterling, Pittsboro, NC (US)

Correspondence Address: Nelson Mullins Riley & Scarborough LLP;IP Department, 100 North Tryon Street, 42nd Floor, Charlotte, NC, 28202-4000, US

(21) Appl. No.: 12/465,367

(22) Filed: May 13, 2009

Related U.S. Application Data
(60) Provisional application No. 61/085,259, filed on Jul. 31, 2008.

(51) Int. Cl. B32B 3/10

(52) U.S. Cl. 428/195.1

(57) ABSTRACT

A camouflage construction comprises a first base layer having a top side defining a first camouflage motif and an opposite bottom side defining a second camouflage motif. A second garnish layer, formed from a plurality of elongated strips each having a central longitudinal axis extending between opposite ends of each strip, and a plurality of slits formed transverse to each strip longitudinal axis so that a plurality of fingers are formed on each side of the longitudinal axis so that each finger has a first end that is attached to a continuous central portion of the strip and a second end that is free to move with respect to the first end and adjacent fingers, are bonded to the first base layer top side along the central longitudinal axes to form a three-dimensional motif on the first base layer top side.

### CLAIM OF PRIORITY

The present application claims priority to U.S. Provisional Patent Application Ser. No. 61/085,259, filed Jul. 31, 2008, entitled Snag Free Reversible Camouflage Netting, the entire disclosure of which is incorporated by reference herein.

### FIELD OF THE INVENTION

The present invention relates to camouflage nets for use in hiding objects, and particularly to camouflage nets that are reversible and snag free.

### BACKGROUND OF THE INVENTION

Camouflaged materials are used to conceal objects, personnel, and equipment in natural terrain, and are typically in the form of drapable sheets of varying shapes and sizes. Camouflaged materials may be dyed or printed in patterns to simulate the coloration or texture of the terrain in which the camouflage is used. Typical examples of colors that may be employed include various patterns of black, brown, and green.

Camouflage nets are generally known, in which leaf-cut material or material which has been perforated in some way is attached to a net structure. One example of prior art nets is illustrated in U.S. Pat. No. 4,931,320. Referring to FIG. 1, a top view shows a portion of a camouflage net where lobes simulate natural objects of a terrain, e.g., leaves or foliage, in a raised random orientation. The composite camouflage net 10 comprises a drapable, small mesh net 12, such as a textile Raschel knit fabric, which may be formed of a suitable textile yarn, such as nylon or polyester. Thread stitches 14 bond, in a one-to-one relation, a continuous sheet 16 of suitable material, such as a woven nylon or polyester fabric of rip-stop construction, to net 12. As seen in FIGS. 1 and 3, continuous sheet 16 is cut between adjacent parallel lines of stitching 14 to form a plurality of lobes 18, each lobe having a base portion 18a attached to mesh net 12 by bonding stitches 14. Prior to bonding sheet 16 to mesh net 12, sheet 16 is stretched to cause each of lobes 18 to buckle so that a loose end portion 18b is free to move to simulate leaves or foliage.

Prior art camouflage nets like that shown in the '320 patent provide a three dimensional camouflage motif on one side as shown in FIG. 1, but are generally a solid color on the opposite side. Moreover, because sheet 16 is a continuous sheet that is cut between the stitching, it cannot be easily draped over an object if the three dimensional side is facing down. In particular, the cut areas 18 create snag points that will catch on projections on the object to be camouflaged thereby tearing continuous sheet 16 and/or pulling the continuous sheet apart from mesh 12. Thus, because prior art netting easily snags on the object to be camouflaged, the user is dissuaded from turning the three dimensional patterned side downward to face the object.

In addition to the snagging properties of prior art nettings, prior art camouflage netting has been formed for single use. That is, while one side of the netting has a camouflage motif (desert, woodland, urban, etc.), the back side of mesh 12 provides no camouflage properties since it is generally a solid color. Thus, when different motifs are necessary, the user must carry more than one camouflage netting, for example one for desert use and one for woodland use. This becomes cumbersome especially when the user must carry the netting when on foot or during times when the amount of cargo that can be carried is limited.

Thus, a need exists for reversible camouflage netting that provides for more than one motif, while the netting is snag free when used in any orientation.

### SUMMARY OF THE INVENTION

The present invention recognizes and addresses disadvantages of prior art constructions and methods, and it is an object of the present invention to provide an improved camouflage netting. This and other objects may be achieved by a camouflage construction comprising a first base layer having a top side, an opposite bottom side, a first camouflage motif formed on the top side, and a second camouflage motif formed on the opposite bottom side. A second garnish layer is formed from at least two elongated strips, each having a central longitudinal axis extending between opposite ends of the strip. A plurality of slits are formed transverse to the strip longitudinal axis so that a plurality of fingers are formed on each side of the longitudinal axis of each respective strip. A first portion of the fingers formed on one of the at least two strips overlap a second portion of the fingers formed on another one of the at least two strips. The at least two elongated strips are bonded to the first base layer top side along the central longitudinal axes, and at least the first camouflage motif is a three-dimensional design.

In some embodiments, the first camouflage motif is in the form of a woodland motif and the second camouflage motif is in the form of a desert motif. In other embodiments, the ratio of strip material to the first base material is at least 1.5:1. In yet other embodiments, the ratio of strip material to the first base material is at least 2.5:1.

In other embodiments, the at least one of the first base layer and the at least two strips contain a coating for blocking thermal emissions. In some embodiments, the at least one of the first base layer and the at least two strips contain a coating for blocking electrical signals.

In another preferred embodiment, a camouflage construction comprises a first base layer having a top side defining a first camouflage motif and an opposite bottom side defining a second camouflage motif. A second garnish layer, formed from a plurality of elongated strips each having a central longitudinal axis extending between opposite ends of each strip, and a plurality of slits formed transverse to each strip longitudinal axis so that a plurality of fingers are formed on each side of the longitudinal axis so that each finger has a first end that is attached to a continuous central portion of the strip and a second end that is free to move with respect to the first end and adjacent fingers, are bonded to the first base layer top side along the central longitudinal axes to form a three-dimensional motif on the first base layer top side.

In some embodiments, the second ends of the fingers on one of the plurality of elongated strips overlap the second ends of the fingers formed on an adjacent another one of the plurality of elongated strips so that the amount of material used to form the second garnish layer is greater than the amount of material used to form the first base layer. In these embodiments, the ratio of strip material to the first base material is at least 1.5:1. In the alternative, the ratio of strip material to the first base material is at least 2.5:1.

In yet other embodiments, the at least one of the first base layer and the plurality of strips contain a coating for blocking thermal emissions. In other embodiments, the at least one of the first base layer and the plurality of strips contain a coating for blocking electrical signals.

In yet other embodiments, the first camouflage motif is chosen from one of a woodland, tropical and forest motif, and the second camouflage motif is chosen from one of a desert, woodland, tropical, forest and urban motif.

In yet another preferred embodiment, a camouflage construction comprises a first base layer having a top side, an opposite bottom side, a first camouflage motif formed on the top side and a second camouflage motif formed on the opposite bottom side. A second garnish layer is formed from at least two elongated strips each having a central longitudinal axis extending between opposite ends of the strip, and a plurality of slits formed transverse to the strip longitudinal axis so that a plurality of fingers are formed on each side of the longitudinal axis. The at least two elongated strips are bonded to the first base layer top side along the respective strip central longitudinal axes, and the first camouflage motif is a three-dimensional design.

In some embodiments, the second ends of the fingers on one of the plurality of elongated strips overlap the second ends of the fingers formed on an adjacent another one of the plurality of elongated strips. In these embodiments, a ratio of strip material to the first base material is in a range of approximately 1:1 to 3:1.

In other embodiments, at least one of the first base layer and the at least two strips contain a coating for blocking at least one of thermal emissions and electrical signals.

In yet other embodiments, the first camouflage motif is chosen from one of a woodland, tropical and forest motif, and the second camouflage motif is chosen from one of a desert, woodland, tropical, forest and urban motif.

In one embodiment, the at least two elongated strips are bonded to the first base layer by stitching. In yet another embodiment, the at least two elongated strips are bonded to the first base layer by glue.

### BRIEF DESCRIPTION OF THE DRAWINGS

A full and enabling disclosure of the present invention, including the best mode thereof directed to one of ordinary skill in the art, is set forth in the specification, which refers to the appended figures, in which:

FIG. 1 is a plan view of a prior art embodiment of camouflage netting;

FIG. 2 is a side view of the prior art netting of FIG. 1;

FIG. 3 is a plan view of the prior art netting of FIG. 1;

FIG. 4 is an embodiment of a reversible camouflage netting in accordance with the present invention;

FIG. 5 is a partial top section view of the reversible camouflage netting of FIG. 4; and

FIG. 6 is a side sectional view of the reversible camouflage netting of FIG. 4.

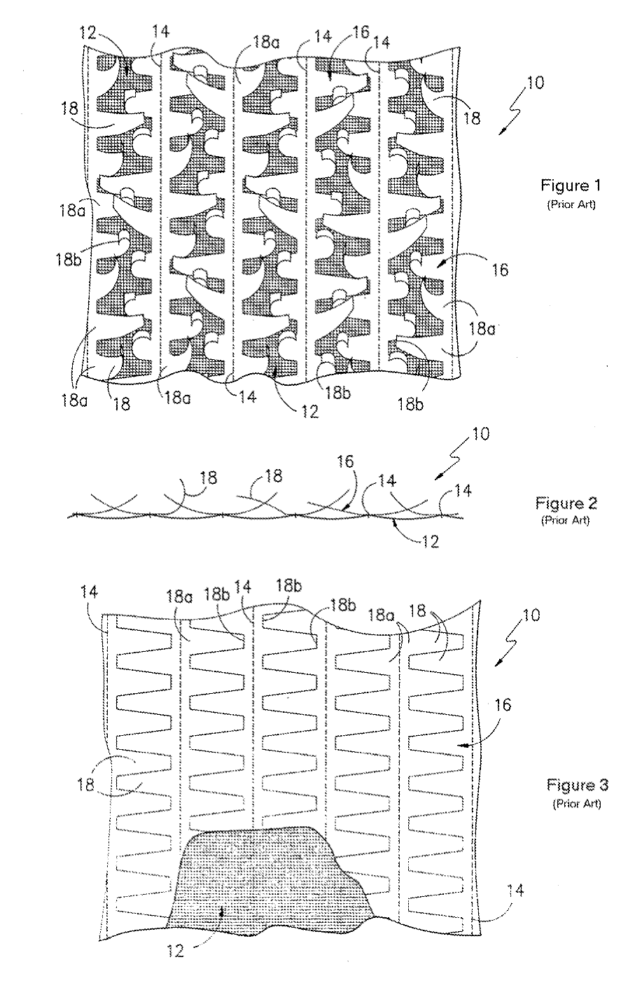

Repeat use of reference characters in the present specification and drawings is intended to represent same or analogous features or elements of the invention.

### DETAILED DESCRIPTION OF THE INVENTION

One of ordinary skill in the art will understand that the present discussion is a description of exemplary embodiments only, and is not intended as limiting the broader aspects of the present invention, which broader aspects are embodied in the exemplary construction.

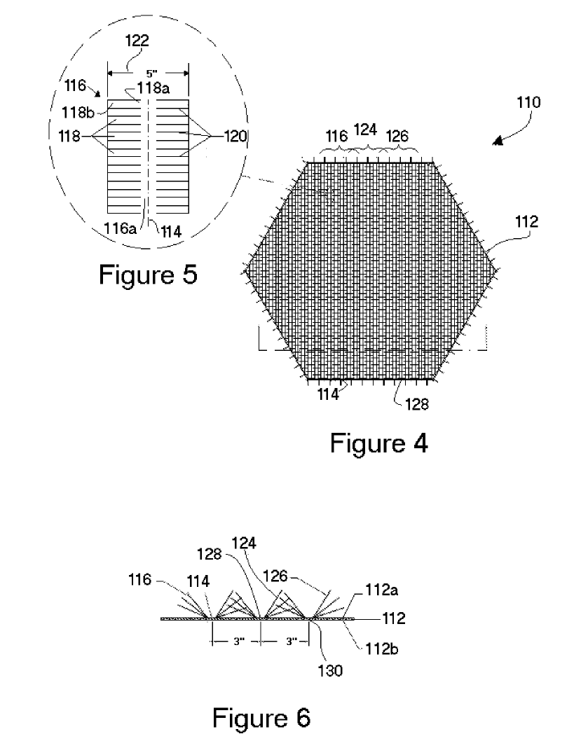

Referring to FIG. 4, one embodiment of the invention comprises a multi-layered camouflage construction 110 having a first mesh layer 112 defined by a top side 112a and a bottom side 112b (FIG. 6). A second garnish layer, formed from a plurality of garnish strips 116, 124 and 126, is bonded to first mesh layer 112 by at lease one stitch line 114. In this particular embodiment, first mesh layer 112 is formed from a polymer, such as polyester tricot knit, nylon or other suitable material formed in an open mesh configuration. The size of the openings in mesh 12 may vary depending on the application of camouflage construction 110 and desired properties needed.

A camouflage pattern is formed on mesh top side 112a by painting, coating, printing or any other suitable manner that permanently disposes a camouflage pattern on the mesh layer. In one preferred embodiment, the pattern is formed by a coating containing a mix of adhesives, pigments, ultraviolet absorbers and flame retardants that is applied and cured so that the adhesive molecules bond with the molecules of the mesh material. It should be understood that other types of materials may be included in the coating to change the camouflage characteristics of the mesh. For example, in addition to visual camouflage, materials may be added to provide electronic camouflage and thermal camouflage.

Referring to FIG. 5, a close up view is shown of one strip 116 that together with a plurality of other strips forms the second garnish layer. In one embodiment, each strip is five inches wide (122), and is attached to mesh top side 112a by stitch line 114 along a center portion 116a of strip 116. It should be understood that the strips may be attached by adhesives and other suitable bonding materials that provide a strong bond between mesh 112 and the plurality of strips that make up the garnish layer.

Strip 116 contains a plurality of fingers 118, separated by slits 120 formed transverse to stitch line 114, and located on each side of strip center portion 116. Fingers 118 have a first end 118a that is connected to strip center portion 116a and a second end 118b that is free to move with respect to the other plurality of fingers on strip 116 and to fingers formed on adjacent strips, such as strip 124. Thus, fingers 118 bend and twist so that the plurality of fingers forms a three dimensional garnish layer that is attached to mesh 112.

Strip 116 may be formed from a similar material as mesh 112, and in a similar configuration. In this way, camouflaged construction 110 allows for air flow through construction 110, which in addition to allowing air to enter under camouflage construction 110 to cool the objects and personnel being hidden, also prevents the wind from being caught under the construction. This is particularly useful in applications of the construction as a drape or covering over large pieces of equipment in which wind or air resistance may become a significant factor due to the large surface area exposed to wind.

It should be understood that the strips may have the same coloring as mesh 112a, or it may contain a different camouflage pattern that compliments the pattern formed on mesh top side 112a. Moreover, the coatings applied to the strips that make up the garnish layer may be the same as that applied to mesh layer 112, or it may contain additional materials to provide varying camouflage properties. For example, coatings materials may block other radiation such as radar, radio waves, thermal emissions, light waves, etc. depending on the application of the construction. Moreover, instead of coatings, these blocking materials may be disposed in the pigments and adhesives that are applied to form the camouflage pattern on construction 110.

Referring to FIG. 6, a portion of construction 112 is shown having a plurality of strips 116, 124 and 126 bonded to mesh top side 112a by stitch lines 114, 128 and 130. Strips 116, 124 and 126 are positioned on mesh 112 with a spacing that allows the fingers on adjacent strips to overlap. In one embodiment shown in the figures, five inch wide strips are bonded on three inch spaced apart centers so that the ratio of the garnish layer to mesh layer is 5:3. The overlapped nature of the fingers is beneficial in providing additional blocking of objects and personnel located under camouflage construction 110. That is, the denser the three-dimensional camouflage pattern and material, the better the blocking properties. For example, a three-dimensional camouflage construction with a 1:1 ratio of garnish material to base net material provides less thermal blocking than a 2:1 ratio of garnish material to base material.

In one embodiment of the present invention, the 5:3 ratio results in a camouflage construction that weighs twelve ounces per square yard. It should be understood that in the present invention, the overlap of garnish strips may be varied to achieve a range of overlap from a ratio less than 1:1 to a ratio greater than 4.5:1 depending on the application of construction 110. The larger the ratio, the better the visual, thermal and electronic blocking properties of construction 110. In other embodiments, with all factors remaining same, i.e. material construction and material weight, a lower overlap ratio provides a lighter camouflage netting. Thus, for certain applications, it should be understood that a 1:1, or less, overlap ratio provides sufficient visual, thermal and electronic blocking properties.

The stitching material used to secure the plurality of strips to mesh top side 112a may be formed from such materials as polyester, nylon or any suitable material, of suitable color for the application and pattern of camouflage construction 110. In some cases the material is chosen to withstand intense heat conditions, in other cases the material is chosen for its low shrink properties, and yet in other applications the material may be chosen for its waterproof properties in combination with other properties such as heat resistance and low shrinkage.

Referring again to FIGS. 4 and 5, the above description was directed to the formation and structure of a three-dimensional camouflage motif that is formed on mesh top side 112a. In some embodiments of the present invention, a second camouflage motif is formed on mesh bottom side 112b to provide a reversible camouflage construction. The second motif may be a two-dimensional motif such as that used in a desert setting or it may also take the form of a three-dimensional motif for use in other types of settings that differ from the three-dimensional motif formed on mesh top side 112a. In one preferred embodiment, the second motif is a two dimensional desert motif. Thus, camouflage construction 110 provides a reversible camouflage netting that can be used with the first three-dimensional motif facing outward for use in a tropical or woodland settings, and the second two-dimensional motif facing outward for desert settings.

The camouflage construction of the present invention allows for reversible use since there are no loops or areas in the three-dimensional motif that would cause snagging when used in a face down position. That is, in prior art constructions, the second garnish layer is formed from a continuous sheet that is perforated to form lobes that can be bent or wrinkled to create the three-dimensional motif. The second garnish layer is then sewn to the base mesh layer in various places as the garnish layer is stretched, which causes the lobes to buckle or wrinkle. Because the continuous sheet contains connections points between the perforations, snag points are created in the prior art that can get caught up on various parts of the objects being covered.

In the present invention, however, the second garnish layer is not formed from a single continuous layer that is perforated either before or after being attached to the base mesh. Instead, the second garnish layer is formed from a plurality of strips that contain a single stitch line along the length of the strip. The slits are then made transverse to the stitch line so that fingers are formed having a single connection point. In this configuration, while the fingers can be made to overlap, there are no connection points between the finger ends or between adjacent strips that would create areas that would easily become snagged on the underlying object to be covered.

It should be understood that while the above embodiments were described mainly in relation to desert and woodland motifs, other such motifs are contemplated within the scope of the present invention. Such motifs may include tropical motifs, urban motifs, mountainous motifs etc. The reversible camouflage construction of the present invention would typically be formed with at least one three-dimensional camouflage motif and one two-dimensional motif formed on the opposite side. However, it should be understood that two mutually exclusive three-dimensional motifs may be formed on opposite sides of mesh 112. In fact, each side may provide different camouflage properties that work in conjunction with the camouflage properties of the opposite side.

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged both in whole and in part. Furthermore, those of ordinary skill in the art will appreciate that the foregoing description is by way of example only, and is not intended to limit the invention so further described in such appended claims. Therefore, the spirit and scope of the appended claims should not be limited to the description of the preferred versions contained therein.

What we claim is:

1. A camouflage construction comprising:
a. a first base layer having
i. a top side,
ii. an opposite bottom side,
iii. a first camouflage motif formed on said top side, and
iv. a second camouflage motif formed on said opposite bottom side; and
b. a second garnish layer formed from at least two elongated strips, said elongated strips having
i. a central longitudinal axis extending between opposite ends of the strip,
ii. a plurality of slits formed transverse to said strip longitudinal axis so that a plurality of fingers are formed on each side of said longitudinal axis,
wherein
a first portion of said fingers formed on one of said at least two strips overlap a second portion of said fingers formed on another one of said at least two strips,
said at least two elongated strips are bonded to said first base layer top side along said central longitudinal axes, and
wherein at least said first camouflage motif is a three-dimensional design.

2. The camouflage construction of claim 1 wherein said first camouflage motif is in the form of a woodland motif and said second camouflage motif is in the form of a desert motif.

3. The camouflage construction of claim 1 wherein the ratio of strip material to said first base material is at least 1.5:1.

4. The camouflage construction of claim 3 wherein the ratio of strip material to said first base material is at least 2.5:1.

5. The camouflage construction of claim 1 wherein at least one of said first base layer and said at least two strips contain a coating for blocking thermal emissions.

6. The camouflage construction of claim 1 wherein at least one of said first base layer and said at least two strips contain a coating for blocking electrical signals.

7. A camouflage construction comprising:
a. a first base layer having
i. a top side defining a first camouflage motif,
ii. an opposite bottom side defining a second camouflage motif,
b. a second garnish layer formed from a plurality of elongated strips, each of said plurality of elongated strips having
i. a central longitudinal axis extending between opposite ends of each strip,
ii. a plurality of slits formed transverse to each said strip longitudinal axis so that a plurality of fingers are formed on each side of said longitudinal axis so that each finger has a first end that is attached to a continuous central portion of said strip and a second end that is free to move with respect to said first end and adjacent fingers,
wherein said plurality of strips are bonded to said first base layer top side along said central longitudinal axes to form a three-dimensional motif on said first base layer top side.

8. The camouflage construction of claim 7 wherein said second ends of said fingers on one of said plurality of elongated strips overlap said second ends of said fingers formed on an adjacent another one of said plurality of elongated strips so that the amount of material used to form said second garnish layer is greater than the amount of material used to form said first base layer.

9. The camouflage construction of claim 8 wherein the ratio of strip material to said first base material is at least 1.5:1.

10. The camouflage construction of claim 8 wherein the ratio of strip material to said first base material is at least 2.5:1.

11. The camouflage construction of claim 7 wherein at least one of said first base layer and said plurality of strips contain a coating for blocking thermal emissions.

12. The camouflage construction of claim 7 wherein at least one of said first base layer and said plurality of strips contain a coating for blocking electrical signals.

13. The camouflage construction of claim 7 wherein said first camouflage motif is chosen from one of a woodland, tropical and forest motif, and said second camouflage motif is chosen from one of a desert, woodland, tropical, forest and urban motif.

14. A camouflage construction comprising:
a. a first base layer having
i. a top side,
ii. an opposite bottom side,
iii. a first camouflage motif formed on said top side, and
iv. a second camouflage motif formed on said opposite bottom side; and
b. a second garnish layer formed from at least two elongated strips, said elongated strips having
i. a central longitudinal axis extending between opposite ends of the strip,
ii. a plurality of slits formed transverse to said strip longitudinal axis so that a plurality of fingers are formed on each side of said longitudinal axis,
wherein
said at least two elongated strips are bonded to said first base layer top side along said respective central longitudinal axes, and
said first camouflage motif is a three-dimensional design.

15. The camouflage construction of claim 14, wherein said second ends of said fingers on one of said plurality of elongated strips overlap said second ends of said fingers formed on an adjacent another one of said plurality of elongated strips.

16. The camouflage construction of claim 15, wherein a ratio of strip material to said first base material is in a range of approximately 1:1 to 3:1.

17. The camouflage construction of claim 14, wherein at least one of said first base layer and said at least two strips contain a coating for blocking at least one of thermal emissions and electrical signals.

18. The camouflage construction of claim 14 wherein said first camouflage motif is chosen from one of a woodland, tropical and forest motif, and said second camouflage motif is chosen from one of a desert, woodland, tropical, forest and urban motif.

19. The camouflage construction of claim 14, wherein said at least two elongated strips are bonded to said first base layer by glue.

20. The camouflage construction of claim 14, wherein said at least two elongated strips are bonded to said first base layer by stitching.
